(19) United States
(12) Patent Application Publication
(10) Pub. No.: US 2007/0084007 A1
(43) Pub. Date: Apr. 19, 2007

(54) Securing apparatus for wiper spoiler

(75) Inventor: Robin Hwa, His Chih City (TW)

Correspondence Address: LEONG C LEI, PMB # 1008, 1867 YGNACIO VALLEY ROAD, WALNUT CREEK, CA, 94598, US

(73) Assignee: GREAT PERFORMANCE INDUSTRIES CO., LTD.

(21) Appl. No.: 11/249,367

(22) Filed: Oct. 14, 2005

(51) Int. Cl. B60S 1/38

(52) U.S. Cl. 15/250.201; 15/250.44

(57) ABSTRACT

A securing apparatus for wiper spoiler is disclosed. The securing apparatus comprises a spoiler plate body mounted with a pair of L-shaped holding plates at the rear top edge of the spoiler plate body, the holding plate having an elongated hole to allow the spoiler plate being mounted onto the frame of the wiper with the holding plate, characterized in that the circumference edge of the elongated hole of the holding plate has a short slot and a rhombic shaped securing plate having a screw hole at the center thereof such that the securing plate is positioned at the bottom edge of the frame of the wiper, allowing a screw nut to tight onto the securing plate via the elongated holes of the holding plate and the frame of the wiper and lock the spoiler onto the wiper, and the end edge of the securing plate urges the wall face of the frame of the wiper at the different angle, and the spoiler is suitable for all kinds of wipers.

### BACKGROUND OF THE INVENTION

(a) Technical Field of the Invention

The present invention relates to securing apparatus, and in particular, a securing apparatus for wiper spoiler which also suitable for mounting tightly different types of wipers.

(b) Description of the Prior Art

Generally, the spoiler mounted onto the windshield wiper is L-shaped holding plates, and after the holding plate hooks onto the frame of the wiper, screw nut is used to lock the holding plate and the elongated hole of the frame. Due to various designs of the wipers, the widths of the wipers are different, and therefore the conventional securing apparatus for different wipers can secure the wiper only for a very short period. Frequently, after a period of use, the spoiler becomes loosen and will be dislocated. Accordingly, it is an object of the present invention to provide a securing apparatus for wiper spoiler which mitigates the drawback.

### SUMMARY OF THE INVENTION

The primary purpose of the present invention is to provide a securing apparatus for wiper spoiler having a spoiler plate body mounted with a pair of L-shaped holding plates at the rear top edge of the spoiler plate body, the holding plate having an elongated hole to allow the spoiler plate being mounted onto the frame of the wiper with the holding plate, characterized in that the circumference edge of the elongated hole of the holding plate has a short slot and a rhombic shaped securing plate having a screw hole at the center thereof such that the securing plate is positioned at the bottom edge of the frame of the wiper, allowing a screw nut to tight onto the securing plate via the elongated holes of the holding plate and the frame of the wiper and lock the spoiler onto the wiper, and the end edge of the securing plate urges the wall face of the frame of the wiper at the different angle, and the spoiler is suitable for all kinds of wipers.

Yet another object of the present invention is to provide a securing apparatus for wiper spoiler, wherein the top section of the holding plate is buttoned onto a covering body having decorative patterns.

A further object of the present invention is to provide a securing apparatus for wiper spoiler, wherein the end edge of the securing plate is circular arch shaped facilitating the rotation of the securing plate and urges the wall face of the frame of the wiper at different angle.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of the securing apparatus of the present invention.

FIG. 2 shows a perspective view of the securing apparatus mounted onto the wiper in accordance with the present invention.

FIG. 3 is a perspective view showing the mounting of the securing apparatus onto the frame of the wiper in accordance with the present invention.

FIGS. 4 and 5 are schematic views showing the securing plate of the present invention being mounted onto the frame of the wiper of different width.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

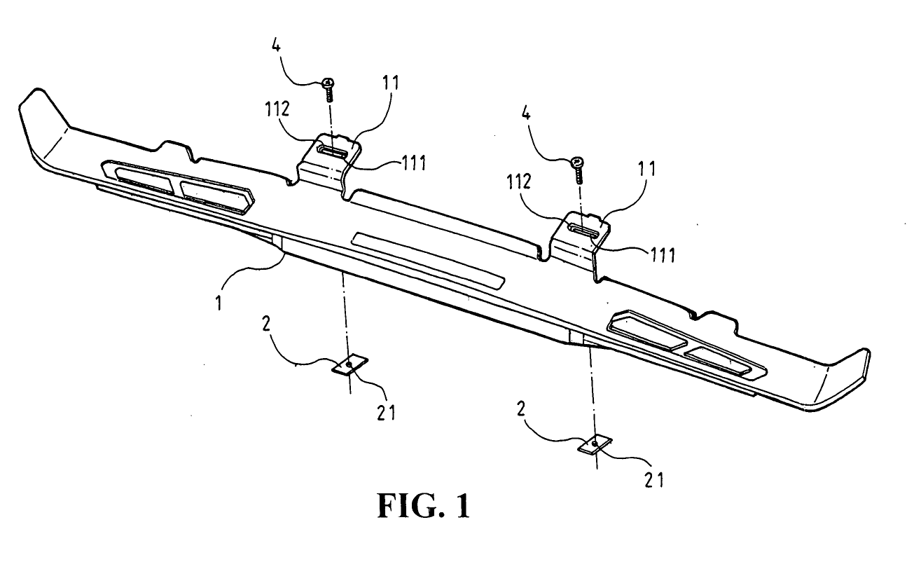

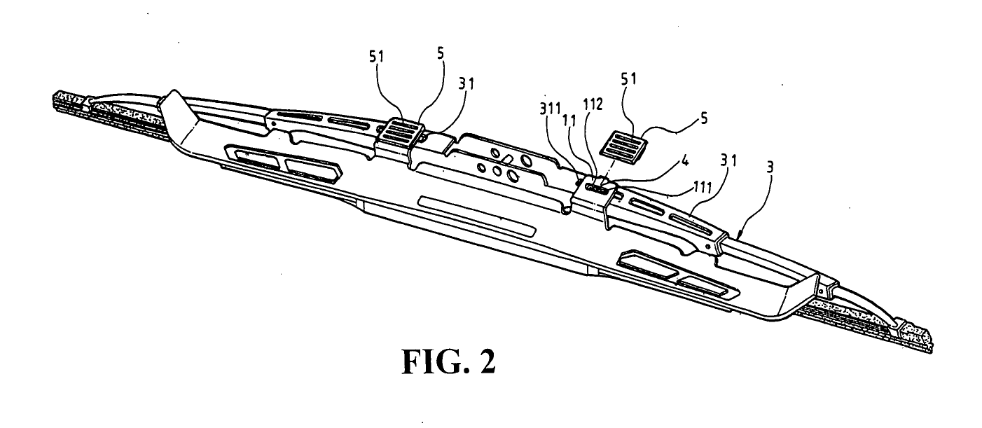

Referring to FIGS. 1 and 2, there is shown a securing apparatus having spoiler body 1 and the rear top edge of the body 1 has a symmetrical L-shaped holding plate 11 with an elongated hole 111. The circumferential edge of the elongated hole 111 has a short slot 112. The securing apparatus includes two securing plates 2 which are rhombic shape. There is a screw hole 21 at the center of the securing plate 2 such that when the spoiler body 1 is mounted onto wiper 3, the holding plate 11 is positioned at the frame 31 of the wiper 3. Screw nut 4 is used to lock the holding plate 11 to the securing plate 2 at the bottom edge of the frame 31 via the elongated hole 111 and 311. Thus, the spoiler body 1 is secured, and the rhombic shape of the securing plate 2 having a circular arch shape allows the securing apparatus be used on wiper of different width.

In accordance with the present invention, the securing apparatus includes two covering bodies 5 having different decorative patterns 51 such that when the two covering plates 5 are locked at the holding plate 11, the plates 5 are fastened at the top section of the holding plate 11 so as to cover the screw nut 4 for decorative purpose to enhance aesthetical effect.

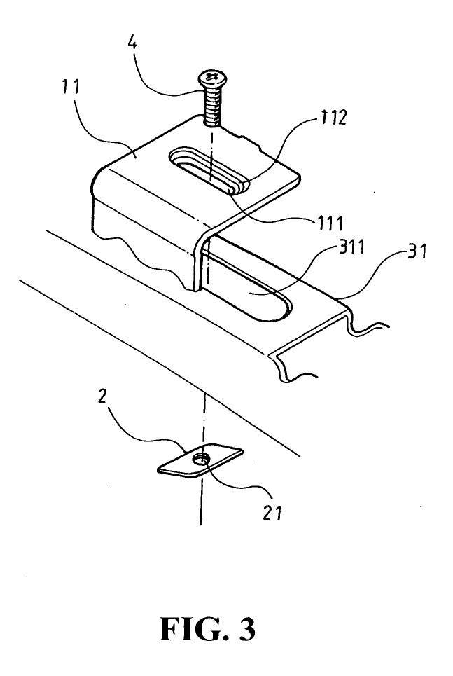

As shown in FIG. 3, in application of the securing apparatus, the securing plate 2 is positioned at the bottom edge of the frame 31 of the wiper 3. The frame 31 is an inverted U-shaped structure to form into a slot. The screw 4 passes through the elongated hole 11 and the elongated hole 311 and locked at the screw hole 21 of the securing plate 2 and therefore, the wiper body 1 is secured at the wiper 3. Thus, when the wiper 3 is triggered in apparatus, the spoiler plate enhances water wiping capability.

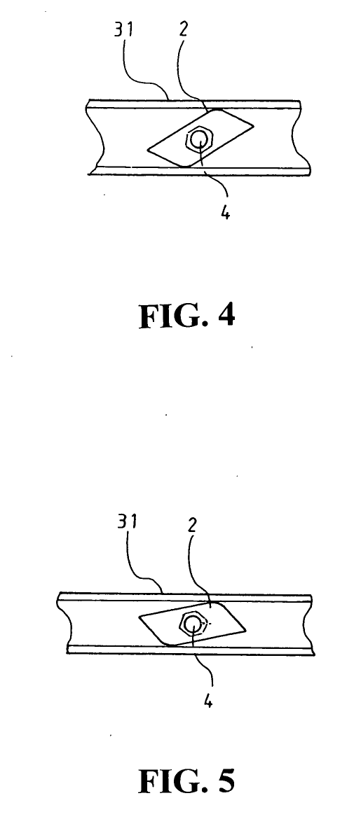

Referring to FIG. 4, when in application, the securing plate 2 is positioned at the bottom edge of the frame 3 of the wiper. When it is locked, the end edge of the securing plate 2 urges the wall face of the frame 31, and thus, the securing plates are secured and inappropriate loosening is avoided.

As shown in FIG. 5, the width of wiper varies from one another, when the securing plate 2 of the securing apparatus is to be locked on to wiper. Due to its rhombic shape and the circular arch shape at the end edge, the securing plate 2 will rotate in accordance with the locking direction of rotation. When the frame 31 is too width or too narrow, the securing plate 2 will urge the wall face of the frame 31 at a different angle such that the similar spoiler can be applied to the wipers of various shape/types. Thus, the value of the wiper spoiler is enhanced.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A securing apparatus for wiper spoiler having a spoiler plate body mounted with a pair of L-shaped holding plates at the rear top edge of the spoiler plate body, the holding plate having an elongated hole to allow the spoiler plate being mounted onto the frame of the wiper with the holding plate, characterized in that the circumference edge of the elongated hole of the holding plate has a short slot and a rhombic shaped securing plate having a screw hole at the center thereof such that the securing plate is positioned at the bottom edge of the frame of the wiper, allowing a screw nut to tight onto the securing plate via the elongated holes of the holding plate and the frame of the wiper and lock the spoiler onto the wiper, and the end edge of the securing plate urges the wall face of the frame of the wiper at the different angle, and the spoiler is suitable for all kinds of wipers.

2. The securing apparatus for wiper spoiler of claim 1, wherein the top section of the holding plate is buttoned onto a covering body having decorative patterns.

3. The securing apparatus for wiper spoiler of claim 1, wherein the end edge of the securing plate is circular arch shaped facilitating the rotation of the securing plate and urges the wall face of the frame of the wiper at different angle.
